(19) United States
(12) Patent Application Publication
(10) Pub. No.: US 2025/0190893 A1
(43) Pub. Date: Jun. 12, 2025

(54) INTELLIGENT RULE CONFIGURATION IN A COLLABORATION SYSTEM

(71) Applicant: SAP SE, Walldorf (DE)

(72) Inventor: Mahesh Vaidyanathan, Bangalore (IN)

(21) Appl. No.: 18/535,060

(22) Filed: Dec. 11, 2023

(51) Int. Cl. G06Q 10/0631

(52) U.S. Cl. CPC G06Q 10/063114

(57) ABSTRACT

The present disclosure involves systems, software, and computer implemented methods for intelligent rule configuration in a collaboration system. One example method includes generating master data that describes central document rejection types for central rejections of documents. Local rejection information that includes local rejection categories and corresponding document fields is extracted for a collaboration partner. The local rejection information is compared to the master data to identify correlated local rejection categories that are correlated to a corresponding central document rejection category by prompting a generative large language model. Correlated local rejection categories are analyzed against predetermined trend rules. In response to determining that a correlated local rejection category satisfies a predetermined trend rule, a transaction rule is identified for the central collaboration system and a rejection insight is provided to the collaboration partner along with a recommendation to configure the transaction rule in the central collaboration system.

### TECHNICAL FIELD

The present disclosure relates to computer-implemented methods, software, and systems for intelligent rule configuration in a collaboration system.

### BACKGROUND

A supply chain can involve various entities. For example, a supply chain can include materials suppliers, manufacturers, distributors, retailers, and a customer. Before a product reaches a customer, various communications and transactions can occur in the supply chain between the other entities in the supply chain. Solutions such as ERP (Enterprise Resource Management) tools can manage supply chain activities.

### SUMMARY

The present disclosure involves systems, software, and computer implemented methods for intelligent rule configuration in a collaboration system. An example method includes: generating, in a central collaboration system that manages collaborations between different collaboration partners, collaboration system master data that describes central document rejection types for central rejections of documents by the central collaboration system of documents provided by collaboration partners to the central collaboration system; extracting, for a first collaboration partner, local rejection information of documents by the first collaboration partner of documents forwarded to the first collaboration partner by the central collaboration system, wherein the local rejection information comprises local rejection categories and corresponding document fields; comparing the local rejection information to the collaboration system master data by prompting a generative large language model, wherein the comparing includes matching at least some of the local rejection categories and document fields in the local rejection information to corresponding central document rejection categories and document fields in the collaboration system master data to identify correlated local rejection categories that are correlated to a corresponding central document rejection category; analyzing correlated local rejection categories against at least one predetermined trend rule; and in response to determining that a first correlated local rejection category satisfies a first predetermined trend rule: identifying a first transaction rule for the central collaboration system that is mapped to the central document rejection category that is correlated to the first correlated local rejection category; and providing, to the first collaboration partner, a rejection insight corresponding to the first predetermined trend rule along with a recommendation for the first collaboration partner to configure the first transaction rule in the central collaboration system.

Implementations can include one or more of the following features. A request can be received from the first collaboration partner to configure the first transaction rule. The first transaction rule can be configured in the central collaboration system for the first collaboration partner. A first document can be received, from a second collaboration partner, that is targeted to the first collaboration partner. The first document can be rejected in the central collaboration system based on the first transaction rule. Generating the collaboration system master data can include prompting a generative large language model to generate the collaboration system master data. Extracting the local rejection information can include prompting a generative large language model to extract the local rejection information. Comparing the local rejection information to the collaboration system master data can include prompting a generative large language model to compare the local rejection information to the collaboration system master data. The collaboration system master data can map central rejection categories and document fields to transaction rules in the central collaboration system. The first transaction rule can be a default rule that is configured for all collaboration partners with which the first collaboration partner collaborates. The first transaction rule can be a group rule that is configured for a particular group of collaboration partners with which the first collaboration partner collaborates. The first transaction rule can be a geographic rule that is configured for all collaboration partners of a particular geographic area with which the first collaboration partner collaborates.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for intelligent rule configuration in a collaboration system.

FIGS. 2A-2B illustrate an example process that can be performed by a collaboration system.

FIG. 2C is a diagram that illustrates analysis with respect to a default transaction rule.

FIGS. 2D-2E are diagrams that illustrate example collaboration partner relationships.

FIG. 2F is a diagram that illustrates analysis with respect to supplier group rules.

FIG. 2G is a diagram that illustrates analysis with respect to supplier country rules.

FIG. 3 is a diagram that illustrates example classification of a local rejection.

FIG. 4 illustrates an example system for intelligent rule configuration in a collaboration system.

FIG. 5 illustrates an example rule recommendation user interface.

FIG. 6 is a flowchart of an example method for intelligent rule configuration in a collaboration system.

FIG. 7 illustrates example large language model information for generating master data for collaboration system transaction rules and associated rejections.

FIGS. 8-11 illustrate example large language model information for generation of rejection category and document fields for ERP rejections.

FIG. 12 illustrates example large language model information for rule matching for ERP rejections.

### DETAILED DESCRIPTION

A central collaboration system can manage transactions and interactions for different participants, which may be referred to as collaboration partners. For example, different collaboration partners may participate in the collaboration system as different supply chain participants. A given collaboration partner can have a local system, such as an ERP (Enterprise Resource Planning) system. The collaboration partner may configure local transaction rules, such as for document processing, in the ERP system. The collaboration partner may also send requests to the central collaboration system to configure separate independent central transaction rules. A document rejection may occur either at the central collaboration system or the collaboration partner system. However, coordination and synchronization of the central rules with the local rules can be resource intensive and error prone. A situation can occur in which a ERP system has a local rule configured, but where a corresponding rule is not configured in the central collaboration system.

As described below, an automated system can be used to generate transaction rules recommendations so that local collaboration partner rules are reflected in the central collaboration system based on an automatic determination of central rules that match local rules but are not currently configured in the central collaboration system. Configuring rules in the central collaboration system based on the recommendations can result in (1) faster rejections when rejections are appropriate and (2) reduction of data transfer costs since a document rejected by the central collaboration system might not need to be sent on to a destination collaboration partner. The sending collaboration partner can be notified of the rejection before or without the document being sent to the target collaboration partner, for example. Proper validation of documents can then occur when documents are received at or created in the central collaboration system. Other details and advantages are discussed below.

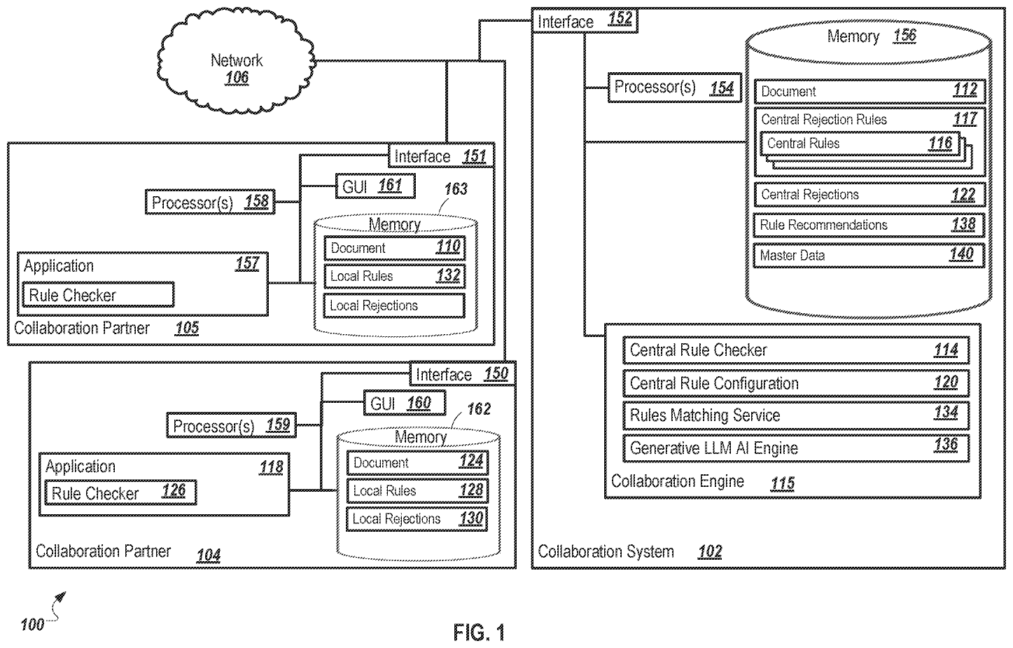

FIG. 1 is a block diagram illustrating an example system 100 for intelligent rule configuration in a collaboration system. Specifically, the illustrated system 100 includes or is communicably coupled with a collaboration system 102, a collaboration partner 104, a collaboration partner 105, and a network 106. Although shown separately, in some implementations, functionality of two or more systems or servers may be provided by a single system or server. In some implementations, the functionality of one illustrated system, server, or component may be provided by multiple systems, servers, or components, respectively.

The collaboration system 102 can manage collaborations between different collaboration partners in a collaboration system, such as the collaboration partners 104 and 105. As one example, the collaboration system 102 can manage collaboration regarding documents. For example, the collaboration system 102 can manage processing of documents sent between collaboration partners. For instance, the collaboration partner 105 can send a document 110 to the collaboration system 102 that is targeted to the collaboration partner 104. The collaboration system 102 can receive the document 110 as a document 112. Before sending the document 112 to the collaboration partner 104, a central rule checker 114 in a collaboration engine 115 of the collaboration system 102 can evaluate the document 112 with respect to central rules 116 in a central rules repository 117 that are relevant to the collaboration partner 104. An administrator of the collaboration partner 104 may have previously used an application 118 to send one or more rule configuration requests to a central rule configuration engine 120 to configure the central rules 116 in the collaboration system 102 for the collaboration partner 104, for example.

The central rule checker 114 may, in response to evaluating the document 112, generate one or more central rejections 122 based on one or more of the central rules 116 that are relevant to a document type of the document 112. As a particular example, the collaboration partner 105 may be a supplier system from which the collaboration partner 104 can obtain one or more items and the document 112 may be an invoice for item(s) the collaboration partner 104 received from the collaboration partner 105. The central rules 116 for invoice documents for the collaboration partner 104 may include rules such as an invoice amount for the invoice should not exceed a purchase order amount of a corresponding purchase order, an invoice date should be later than a corresponding purchase order date, etc. The collaboration system 102 can notify the collaboration partner 105 about any central rejections 122 that may occur based on evaluation of the document 112.

The central rule checker 114 may evaluate the document 112 according to a hierarchy of rules. For example, the collaboration partner 104 may have configured in the central rules 116 geographic location rules that are specific to documents received from partners in a particular geographic location. If the collaboration partner 105 is located in a geographic location for which a geographic location rule has been defined, the geographic location rule can be applied to the document 112. As another example, the collaboration partner 104 may have configured partner group rules in the central rules 116 that are specific to documents received from partners in particular partner groups. If the collaboration partner 105 is included in a partner group for which a partner group rule has been defined for the collaboration partner 104, the partner group rule can be applied to the document 112. The collaboration partner 104 may also have configured default rules in the central rules 116 that can be applied to documents received from any partner that has a relationship with the collaboration partner 104, for rules that otherwise are not applicable to other hierarchical rules. A hierarchy of rules can exist, for example, such that some rules override other rules. For example, a partner group rule may override a corresponding geographic rule (or vice versa), and a geographic location rule and/or a partner group rule may override a default rule. The default rule can apply if no geographic location rules and no partner group rules apply, for example.

If the document 112 passes the central rules 116 for the type of the document 112 and the collaboration partner 104, the collaboration system 102 can send the document 112 to the collaboration partner 104. The document 112 can be received by the collaboration partner 104 as a document 124. A rule checker 126 of the collaboration partner 104 can evaluate the document 124 with respect to local rules 128. The rule checker 126 may determine one or more local rejections 130 based on local evaluation of the document 124 with respect to the local rules 128. The local rules 128 may include similar rules as the central rules 116 but the local rules 128, and the central rules 116 can also include different types of rules. For example, the local rules 128 may include rules specific to a geographic location of the collaboration partner 104, and the collaboration system 102 may not be aware of or allow configuration of such rules in some cases. The local rules 128 may also be structured in a hierarchy of rules. The collaboration system 102 is generally not aware of exact details of the local rules 128 of the collaboration partner 104, nor of local rules of other collaboration partners, such as local rules 132 of the collaboration partner 105.

Administrators of the collaboration partner 104 can, over time, configure the local rules 128 and also send requests to the collaboration system 102 to configure similar central rules 116 for the collaboration partner 104 in the collaboration system 102. The local rules 128 can, however, become out of sync with the central rules 116 for the collaboration partner 104. For example, there may be local rules 128 for which there are no corresponding central rules 116, for cases where the central rules 116 could include a corresponding rule. An administrator may forget to configure a corresponding central rule 116 for some local rules 128, for example, or may edit a local rule 128 and not request a corresponding change to a central rule 116. As another example, rules that should generally correspond between the collaboration partner 104 and the collaboration system 102 may have been misconfigured in one or both systems to cause a mismatch. As yet another example, rules for a newly onboarded collaboration partner that partners with the collaboration partner 104 may be only configured in the collaboration partner 104 or may be disabled in the collaboration system 102. As another example, new types of central rules may be introduced in the collaboration system 102 without the collaboration partner being aware of such new rules, even when new rule(s) align with certain local rule(s) 128.

Having a corresponding central rule 116 for a local rule 128, when possible, can be advantageous because for the document 112, for instance, the collaboration partner 105 can be notified of rejections sooner because the document 112 may be rejected by the collaboration system 102 even before the document 112 is evaluated by the collaboration partner 104. Additionally, document evaluation processing and resources by the collaboration partner 104 can be avoided if the collaboration system 102 first determines an issue with the document 112 and rejects it prior to processing. In this example, the document 112 need not be forwarded to the collaboration partner 104, for example, and can be rejected outright by the collaboration system 102.

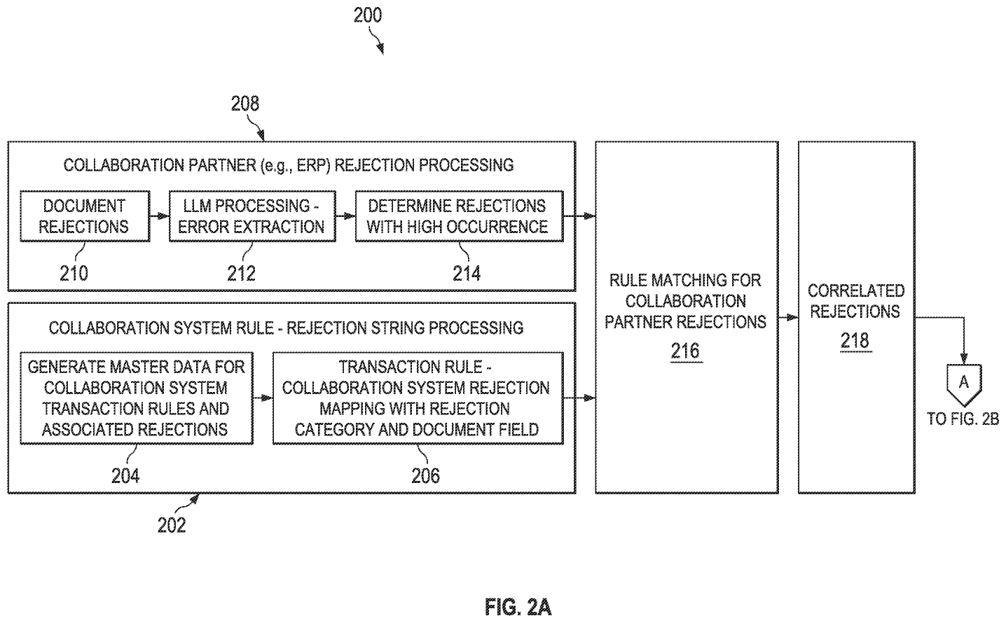

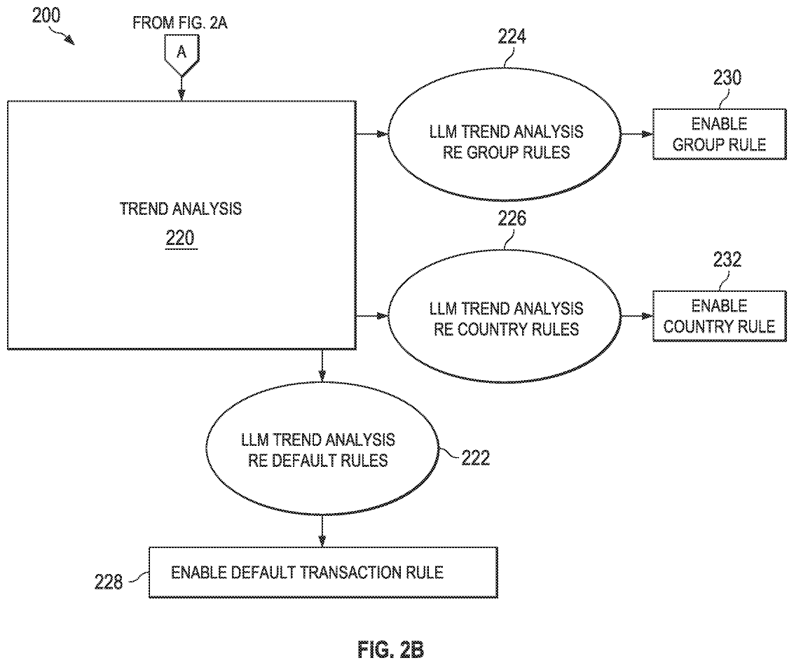

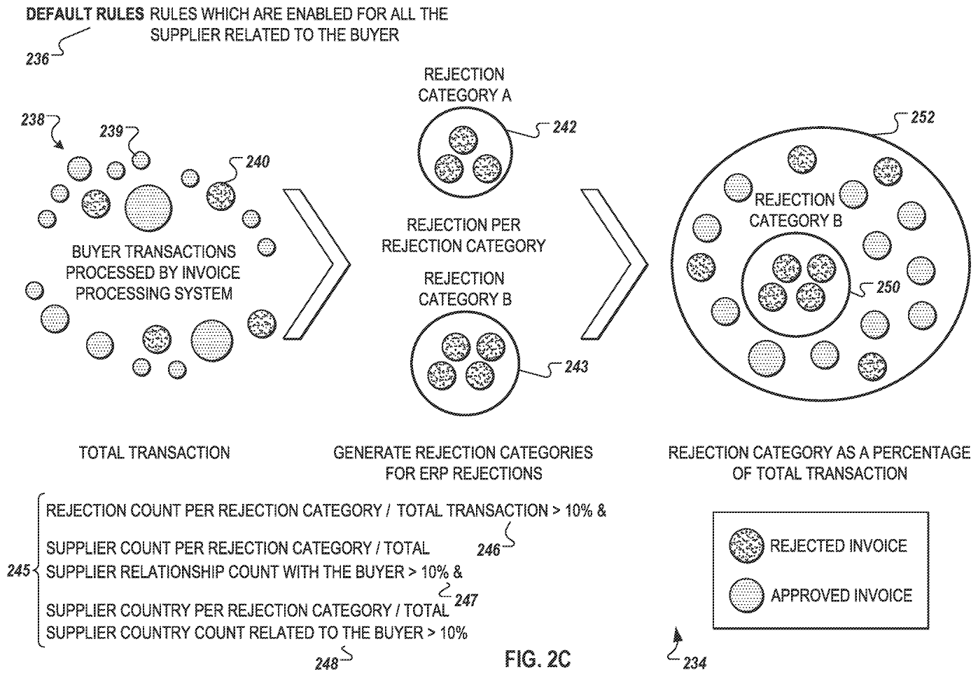

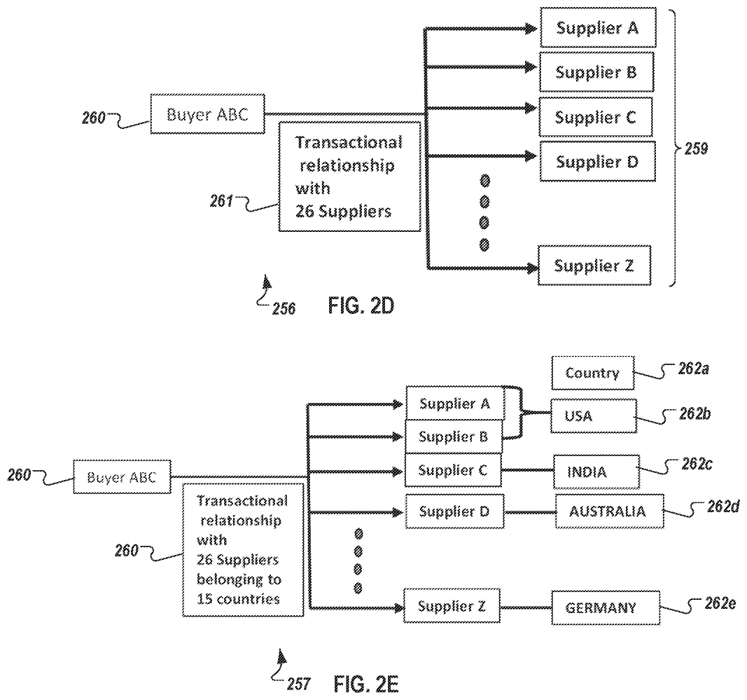

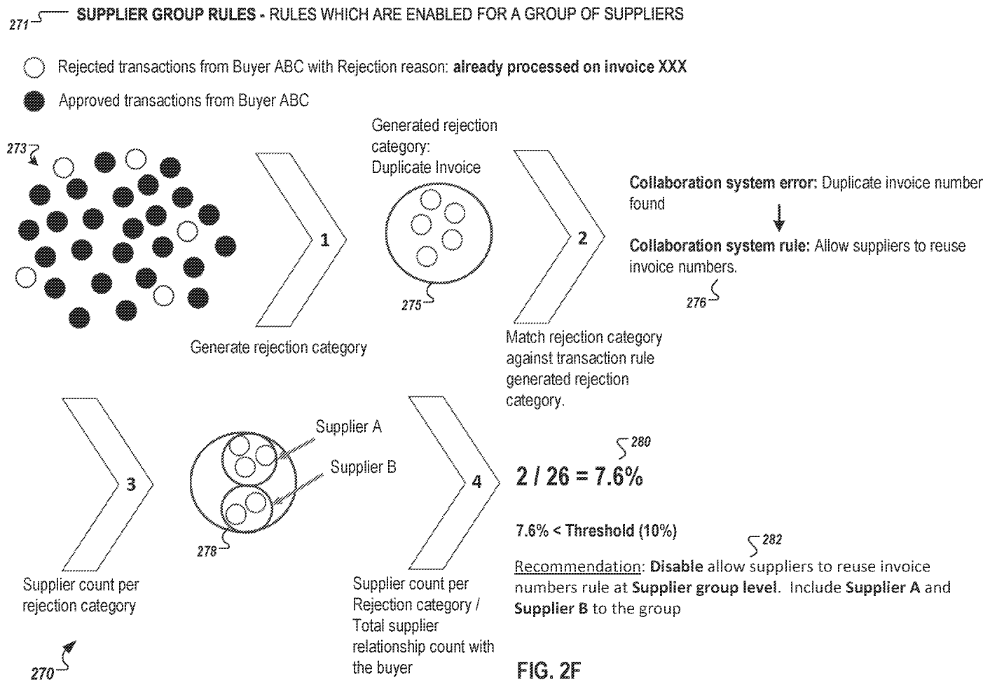

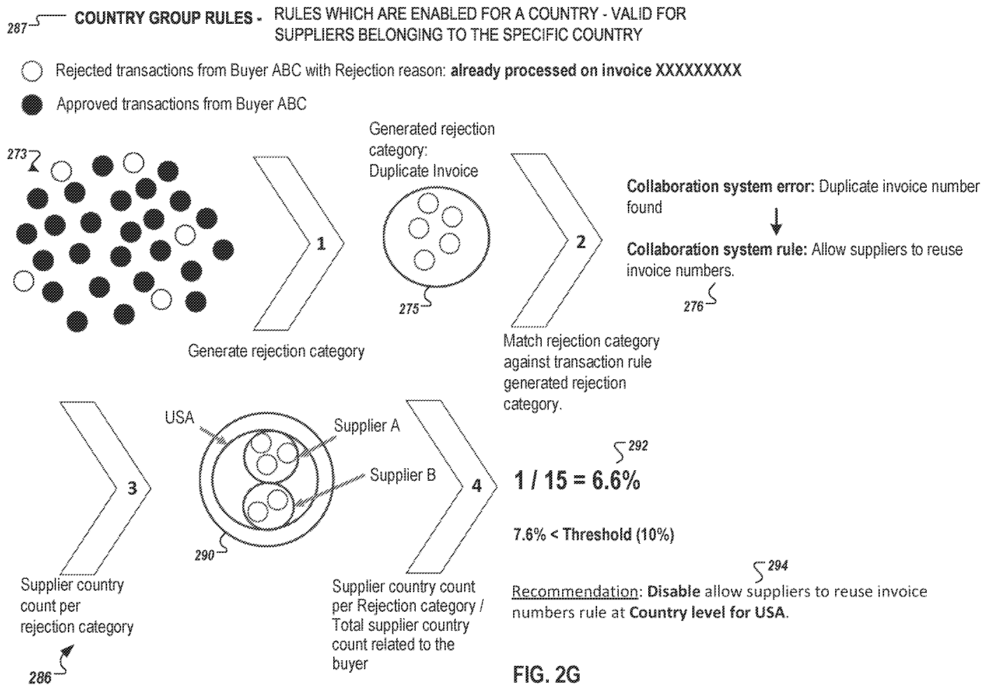

As described in more detail below, a rules matching service 134 and a generative LLM (Large Language Model) AI (Artificial Intelligence) engine 136 in the collaboration engine 115 can perform processing based on received local rejection 130 information 130 to determine if the central rules 116 are missing any rules that could be defined in the collaboration system 102 to match or correspond to any local rules 128. The collaboration engine 115 can generate rule recommendations 138 if the collaboration engine 115 determines that additional rules could potentially be added to the central rules 116 to match corresponding local rules 128. The rule matching service 134 can match received local rejection information 130 to master data 140 that describes types of central rules, for example. The rule recommendations 138 can be provided to the collaboration partner 104 and administrator(s) of the collaboration partner 104 can then send configuration requests to the collaboration system 102 to configure the recommended rules in the central rules 116. Accordingly, document rejections can be generated sooner in document processing and unnecessary processing in the collaboration partner 104 can be avoided for documents that have already been rejected by the collaboration system 102. The collaboration engine 115, and particularly the rules matching service 134, is described in more detail below with respect to FIGS. 2-4.

As used in the present disclosure, the term “computer” is intended to encompass any suitable processing device. The collaboration system 102 and the collaboration partners 104 and 105 may be or include any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the collaboration system 102 and the collaboration partners 104 and 105 may be adapted to execute any operating system, including Linux, UNIX, Windows, Mac OS®, Java™, Android™, iOS or any other suitable operating system. According to one implementation, the collaboration system 102 may also include or be communicably coupled with an e-mail server, a Web server, a caching server, a streaming data server, and/or other suitable server.

Interfaces 150, 151, and 152 are used by the collaboration partner 104, the collaboration partner 105, and the collaboration system 102, respectively, for communicating with other systems in a distributed environment—including within the system 100—connected to the network 106. Generally, the interfaces 150, 151, and 152 each comprise logic encoded in software and/or hardware in a suitable combination and operable to communicate with the network 106. More specifically, the interfaces 150, 151, and 152 may each comprise software supporting one or more communication protocols associated with communications such that the network 106 or interface's hardware is operable to communicate physical signals within and outside of the illustrated system 100.

The collaboration system 102 includes one or more processors 154. Each processor 154 may be a central processing unit (CPU), a blade, an application specific integrated circuit (ASIC), a field-programmable gate array (FPGA), or another suitable component. Generally, each processor 154 executes instructions and manipulates data to perform the operations of the collaboration system 102. Specifically, each processor 154 executes the functionality required to receive and respond to requests from the collaboration partners 104 and 105, for example.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, JavaScript®, Visual Basic, assembler, Perl®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The collaboration system 102 includes memory 156. In some implementations, the collaboration system 102 includes multiple memories. The memory 156 may include any type of memory or database module and may take the form of volatile and/or non-volatile memory including, without limitation, magnetic media, optical media, random access memory (RAM), read-only memory (ROM), removable media, or any other suitable local or remote memory component. The memory 156 may store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the collaboration system 102.

The collaboration partners 104 and 105 may generally be or include any computing device operable to connect to or communicate with the collaboration system 102 via the network 106 using a wireline or wireless connection. In general, the collaboration partners 104 and 105 each comprise at least one electronic computer device operable to receive, transmit, process, and store any appropriate data associated with the system 100 of FIG. 1. The collaboration partners 104 and 105 can each include one or more client applications, including the application 118 or an application 157, respectively. A client application is any type of application that allows the collaboration partners 104 and 105 to request and view content on a client device. In some implementations, a client application can use parameters, metadata, and other information received at launch to access a particular set of data from the collaboration system 102. In some instances, a client application may be an agent or client-side version of the one or more enterprise applications running on an enterprise server (not shown).

The collaboration partners 104 and 105 respectively include processor(s) 158 or 159. Each processor in the processor(s) 158 or 159 may be a central processing unit (CPU), an application specific integrated circuit (ASIC), a field-programmable gate array (FPGA), or another suitable component. Generally, each processor in the processor(s) 158 or 159 executes instructions and manipulates data to perform the operations of the corresponding system. Specifically, each processor in the processor(s) 158 or 159 executes the functionality required to send requests to the collaboration system 102 and to receive and process responses from the collaboration system 102.

The collaboration partners 104 and 105 can each be or include any client computing device such as a laptop/notebook computer, wireless data port, smart phone, personal data assistant (PDA), tablet computing device, one or more processors within these devices, or any other suitable processing device. For example, a client device included in the collaboration partners 104 or 105 may comprise a computer that includes an input device, such as a keypad, touch screen, or other device that can accept user information, and an output device that conveys information associated with the operation of the collaboration system 102, or the respective collaboration partner system itself, including digital data, visual information, or a GUI (Graphical User Interface) 160 or 161, respectively.

The GUIs 160 and 161 can interface with at least a portion of the system 100 for any suitable purpose, including generating a visual representation of a respective client application. In particular, the GUIs 160 and 161 may each be used to view and navigate various Web pages, or other user interfaces. Generally, the GUIs 160 and 161 each provide the user with an efficient and user-friendly presentation of business data provided by or communicated within the system. The GUIs 160 and 161 may each comprise a plurality of customizable frames or views having interactive fields, pull-down lists, and buttons operated by the user. The GUIs 160 and 161 each contemplate any suitable graphical user interface, such as a combination of a generic web browser, intelligent engine, and command line interface (CLI) that processes information and efficiently presents the results to the user visually.

Memory 162 or 163 respectively included in the collaboration partner 104 or 105 may include any memory or database module and may take the form of volatile or non-volatile memory including, without limitation, magnetic media, optical media, random access memory (RAM), read-only memory (ROM), removable media, or any other suitable local or remote memory component. The memory 162 and the memory 163 may each store various objects or data, including user selections, caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the respective collaboration partner system.

There may be any number of collaboration partners associated with, or external to, the system 100. For example, while the illustrated system 100 includes two collaboration partners, alternative implementations of the system 100 may include substantially more than two collaboration partners communicably coupled to the collaboration system 102 and/or the network 106, or any other number suitable to the purposes of the system 100. Additionally, there may also be one or more additional client collaboration partners external to the illustrated portion of system 100 that are capable of interacting with the system 100 via the network 106. Further, the term “client”, “client device” and “user” may be used interchangeably as appropriate without departing from the scope of this disclosure.

FIGS. 2A-2B illustrate an example process 200 that can be performed by the collaboration system. The process 200 includes collaboration system rule/rejection string processing 202. For instance, at 204, the collaboration system can generate master data for collaboration system transaction rules and associated rejections to create a transaction rule/collaboration system rejection mapping 206 with rejection categories and document fields. For example, each collaboration system rejection type can have a rejection string and a document field (e.g., where the field can include a value which may cause or relate to the corresponding rejection). Each collaboration system rejection type can be mapped to a transaction rule in the collaboration system. Accordingly, the mapping 206 can include tuples of mapped transaction rules, collaboration system rejection categories, and corresponding document fields. In some cases, the mapping 206 can be generated using a LLM, as described in more detail below. The mapping 206 can be compared to local rejection information, as described in more detail below.

The process 200 also includes, for example, collaboration partner (e.g., ERP) rejection processing 208. For example, document rejections 210 can be processed during LLM processing/error extraction activities 212. The document rejections 210 may include document rejections for a particular collaboration partner for a particular time period (e.g., the last three months). The document rejections 210 can include rejection information the collaboration partner provided to the collaboration system in response to documents the collaboration system provided to the collaboration partner, for example. The LLM processing/error extraction activities 212 can include extraction of collaboration partner rejection category and corresponding document fields from the document rejections 210. LLM processing for error extraction is described in more detail below.

At 214, the collaboration system can determine local (e.g., collaboration partner) rejection types that have been extracted from the document rejections 210 that have occurred for the collaboration partner more than threshold number of times over the time period. The collaboration system can identify rejections of those frequently-occurring local rejection types for use in rule matching 216 for collaboration partner rejections.

The rule matching 216 can include comparing the frequently-occurring local rejection types to the rejection types in the mapping 206 to identify correlated rejections 218. The correlated rejections 218 include frequently-occurring local rejections that correlate to a corresponding matching collaboration system rejection (e.g., based on category and document field). That is, matching can include matching both rejection categories and document fields in the two datasets. Matching can be performed using LLM processing, as described below. For each correlated rejection 218, a corresponding transaction rule can be identified in the mapping 206 (e.g., based on locating a transaction rule that is mapped to a collaboration system category and document field that have been matched to a local rejection category and document field). A recommendation may be generated for the transaction rule based on trend or other analysis, as described below.

Some frequently-occurring local rejection types may not be correlated to a corresponding collaboration system rejection type. Accordingly, a corresponding transaction rule may not exist in the collaboration system for certain local rejection types, for example. The local rejection type may be specific and only pertain to that given collaboration partner, for example. Accordingly, no central collaboration system recommendations may be generated for some frequently-occurring local rejection types.

As shown in FIG. 2B, trend analysis 220 can be performed on the correlated rejections 218. The trend analysis 220 can lead to trend analysis results 222, 224, or 226, for example. The trend analysis result 222 can lead to generation of a recommendation 228 to enable a default rule in the collaboration system for the collaboration partner. The trend analysis result 224 can lead to generation of a recommendation 230 to enable a group rule in the collaboration system for the collaboration partner. The trend analysis results 226 can lead to generation of a recommendation 232 to enable a country transaction rule in the collaboration system for the collaboration partner.

FIG. 2C is a diagram 234 that illustrates analysis with respect to default transaction rules 236. The default transaction rules 236 are rules that can be enabled for all related collaboration partners (e.g., suppliers) that are related to a particular collaboration partner (e.g., a buyer). The collaboration system can analyze total (e.g., all) transactions 238 occurring with regards to the particular collaboration partner for a particular time period (e.g., the previous month). The total transactions 238 can include transactions corresponding to approved documents (e.g., a transaction 239 relating to an approved invoice) and transactions corresponding to rejected documents (e.g., a transaction 240 relating to a rejected invoice).

The collaboration system can, for transactions relating to rejected documents, group the transactions according to rejection categories. For instance, rejected transactions (e.g., rejections) can be grouped into transactions 242 that have a rejection category A and transactions 243 that have a rejection category B. For a rejection category (e.g., the rejection category B), the collaboration system can evaluate a compound expression 245 to determine whether to recommend configuration of a default transaction rule corresponding to the rejection category. The compound expression 245 includes sub-expressions 246, 247, and 248. The collaboration system can recommend configuration of a default transaction rule corresponding to the rejection category if the collaboration system determines that each of the sub-expressions 246, 247, and 248 evaluate to a value of TRUE for the rejection category.

For example, the collaboration system can evaluate the sub-expression 246 to determine whether the rejection category has a rejection frequency greater than a predetermined threshold. The rejection frequency for a rejection category can be determined as a percentage for the rejection category of the total transactions 238. For example, a circle 250 represents a count of rejected transactions for the rejection category B and a circle 252 represents a count of the total transactions 238. If the count of rejected transactions for the rejection category B divided by the count of the total transactions 238 is greater than a predetermined threshold (e.g., 10%), the collaboration system can identify the rejection category B as a frequently-occurring rejection category.

The collaboration system can also evaluate the sub-expression 247 to determine whether a count of related collaboration partners (e.g., suppliers) for the rejection category divided by a total count of collaboration partners (e.g., suppliers) that have a relationship with the particular collaboration partner (e.g., the buyer) is greater than a predetermined threshold (e.g., 10%). Similarly, the collaboration system can evaluate the sub-expression 248 to determine whether a count of countries of the related collaboration partners (e.g., suppliers) for the rejection category divided by a total country count of collaboration partners (e.g., suppliers) that have a relationship with the particular collaboration partner (e.g., the buyer) is greater than a predetermined threshold (e.g., 10%). As mentioned, if each of the sub-expressions 246, 247, and 248 evaluate to a value of TRUE, the collaboration system can determine to recommend the default transaction rule corresponding to the rejection category. If the compound expression 245 evaluates to a value of FALSE, the collaboration system can do further analysis to determine whether to recommend a group rule or a country rule, as described below with respect to FIGS. 2D and 2E.

FIGS. 2D-2E are diagrams 256 and 257 that illustrate example collaboration partner relationships, respectively. FIG. 2D, for example, illustrates transactional relationships between different suppliers 259 and a buyer 260. A note 261 indicates, for example, that the buyer 260 has a transactional relationship with a total of twenty six suppliers. The example in FIG. 2D is used below for FIG. 2F for a supplier group rule example. FIG. 2E illustrates transactional relationships with respect to geography. For instance, as indicated by a note 262, the buyer 260 has a transactional relationship with twenty six suppliers belonging to a total of fifteen countries, including, for example, countries 262a, 262b, 262c, 262d, and 262e. The example in FIG. 2E is used below for FIG. 2G for a supplier country rule example.

FIG. 2F is a diagram 270 that illustrates analysis with respect to supplier group rules 271. The supplier group rules 271 are rules that can be enabled for a group of collaboration partners (e.g., suppliers) that are related to a particular collaboration partner (e.g., a buyer). A group 273 of transactions for a particular buyer (e.g., buyer “ABC”) includes approved transactions and also some rejected transactions, including transactions rejected by the buyer with a rejection reason of “already processed on invoice XXX.”

In a first step, a collaboration system rejection can be generated for buyer rejections included in the group 273 of transactions, as described above. For example, for the buyer rejections of “already processed on invoice XXX,” a rejection category of “duplicate invoice” can generated and corresponding rejected transactions 275 can be associated with the “duplicate invoice” rejection category. In a second step, the generated rejection category can be matched to a corresponding transaction rule 276 of “allow suppliers to reuse invoice numbers.”

In a third step, a supplier count per rejection category can be determined for each rejection category. For example, as shown in a sub-graph 278, for the generated rejection category of “duplicate invoice”, two suppliers (e.g., supplier “A” and supplier “B”) are associated with rejection transactions of that rejection category. In a fourth step, a ratio 280 of the supplier count per rejection category (e.g., two) to a total supplier relationship count with the buyer (e.g., twenty six) can be determined. As described above with respect to FIG. 2D, the buyer in this example has a relationship with twenty six suppliers. The ratio 280 in this example is thus the supplier count of two divided by twenty six, or a value of 7.6% The ratio 280 can be compared to a predetermined threshold (e.g., 10%). If the ratio 280 is less than the predetermined threshold (e.g., as in this example), a recommendation 282 can be generated to disable the transaction rule 276 at a supplier group level. For instance, the recommendation 282 can be to disable allowing of suppliers to reuse invoice numbers at a supplier group level for a supplier group that includes the supplier “A” and the supplier “B”.

FIG. 2G is a diagram 286 that illustrates analysis with respect to supplier country rules 287. The supplier country rules 287 are rules that can be enabled for a country (e.g., for collaboration partners (e.g., suppliers) belonging to a specific country). In the example of FIG. 2G, a first step and a second step are as described above with respect to FIG. 2F (e.g., for generating a rejection category and matching the rejection category to the transaction rule 276).

In a third step, a supplier country count per rejection category can be determined for each rejection category. For example, as shown in a sub-graph 290, for the generated rejection category of “duplicate invoice”, one country (e.g., “USA”), is the country of the two suppliers (e.g., supplier “A” and supplier “B”) that are associated with rejection transactions of that rejection category. In a fourth step, a ratio 292 of the supplier country count per rejection category (e.g., one) to a total supplier country count related to the buyer (e.g., fifteen) can be determined. As described above with respect to FIG. 2E, the buyer in this example has a relationship with suppliers from fifteen countries. The ratio 280 in this example is thus the supplier country count of one divided by fifteen, or a value of 6.6% The ratio 292 can be compared to a predetermined threshold (e.g., 10%). If the ratio 292 is less than the predetermined threshold (e.g., as in this example), a recommendation 294 can be generated to disable the transaction rule 276 at a country level. For instance, the recommendation 294 can be to disable allowing of suppliers to reuse invoice numbers at a country level for the country of “USA”.

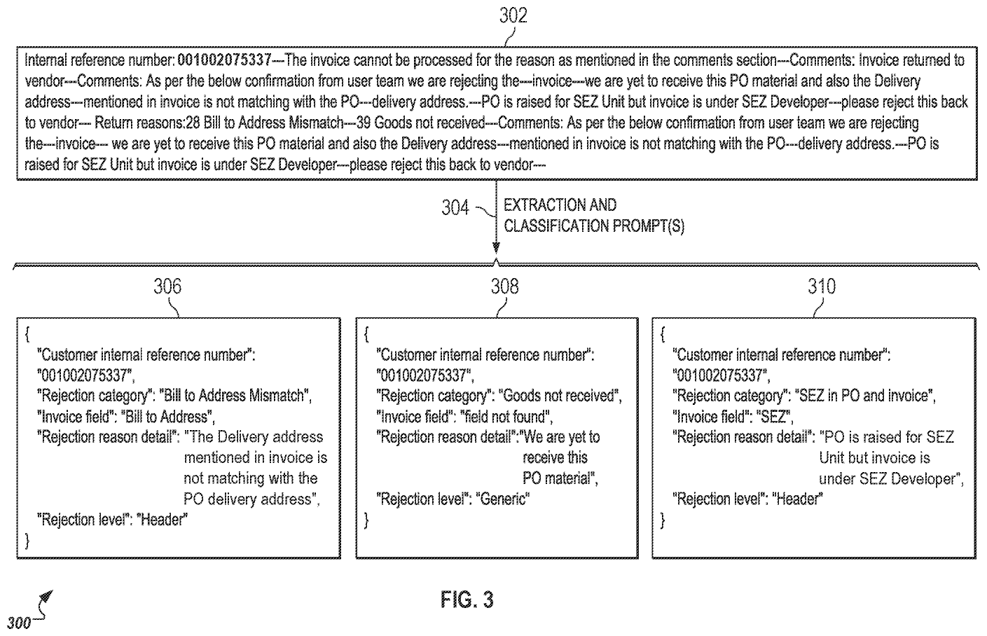

FIG. 3 is a diagram 300 that illustrates example classification of a local rejection. A local rejection 302 is displayed, which may be, for instance, an ERP rejection regarding an invoice document. The local rejection 302 can be processed by one or more extraction and classification LLM prompts 304 to compare rejection category and document field information extracted from the local rejection to central collaboration system rejections. For instance, an LLM prompt may have classified the local rejection 302 as corresponding to corresponding collaboration system rejections 306, 308, and/or 310.

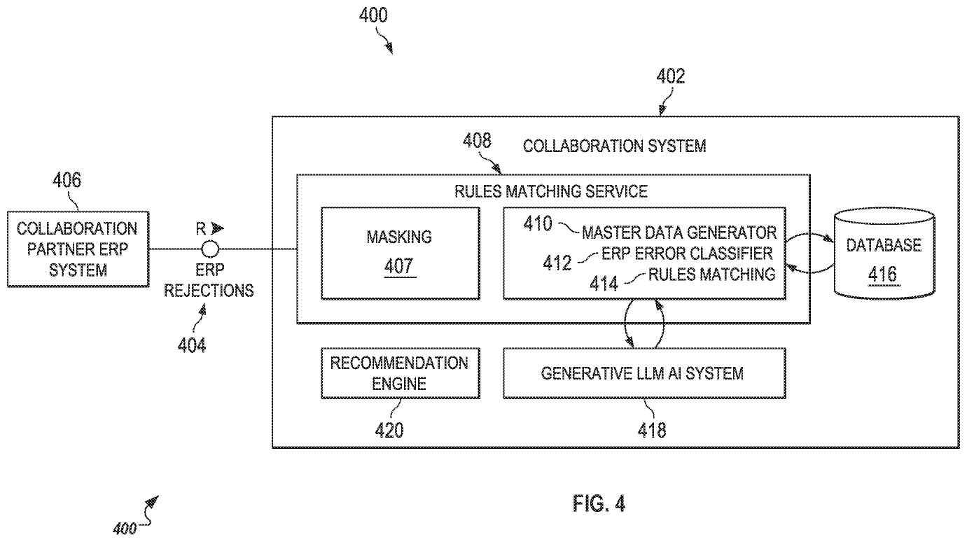

FIG. 4 illustrates an example system 400 for intelligent rule configuration in a collaboration system. A collaboration system 402 can receive ERP rejections 404 from a collaboration partner ERP system 406. The collaboration system 402 can use a masking component 407 to mask personal information in the ERP rejections 404 before the ERP rejections are processed by a rules matching service 408.

The rules matching service 408 can include a master data generator 410 that generates master data for collaboration system rejection categories and transaction rules, an ERP error classifier 412 that can extract ERP rejection categories and document fields from the ERP rejections 404, and a rules matching component 414 that can match ERP rejection information to corresponding master data. The portions of the rule matching service 408 can use a database 416 and a generative LLM AI system 418. The collaboration system 402 can also include a recommendation engine 420 for recommending enablement of transaction rules in the collaboration system 402 based on matches identified by the rules matching component 414 (and possibly based on other trend analyses, as described above).

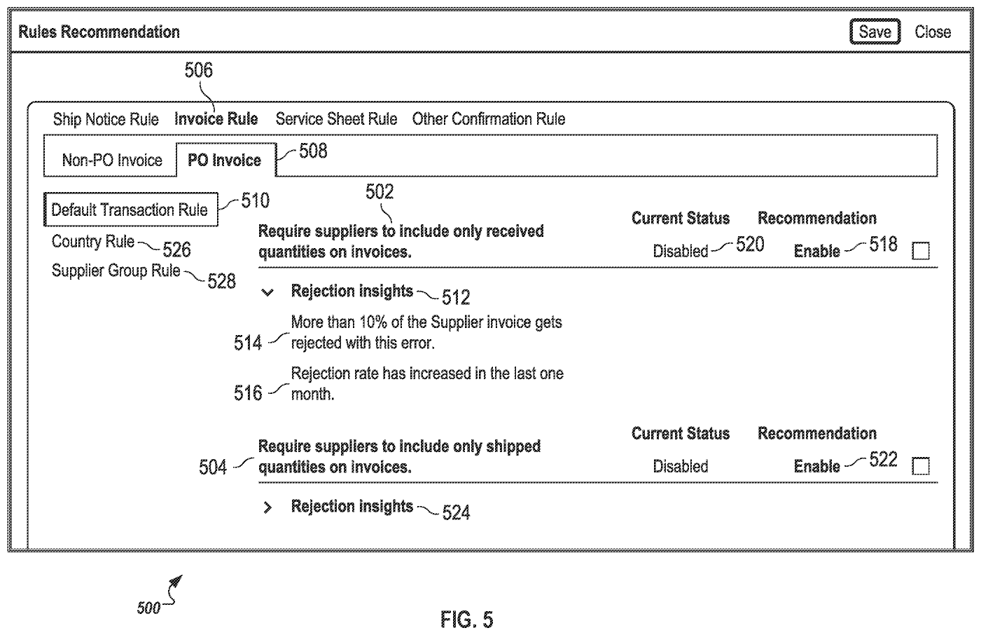

FIG. 5 illustrates an example rule recommendation user interface 500. The rule recommendation user interface 500 displays insights and recommendations to a collaboration partner related to default invoice transaction rules 502 and 504 corresponding to a selected invoice rule tab 506, a selected PO (Purchase Order) invoice tab 508, and a selected default transaction rule tab 510. The default invoice transaction rule 502 specifies that suppliers are required to include only received quantities on invoices. The default invoice transaction rule 504 specifies that suppliers are required to include only shipped quantities on invoices.

A rejection insights area 512 for the default invoice transaction rule 502 includes an insight 514 that indicates that for the collaboration partner, more than ten percent of supplier invoices received for the collaboration partner have been rejected by the collaboration partner according to a local rejection in the collaboration partner related to suppliers not including only received quantities on invoices. Additionally, an insight 516 indicates that a rejection rate for these types of rejections has increased in the last month. Accordingly, the rule recommendation user interface 500 includes a recommendation 518 to enable, in the central collaboration system, the default invoice transaction rule 502, which would be a change from a current status 520 of disabled for the default invoice transaction rule 502.

The rule recommendation user interface 500 also includes a recommendation 522 to enable the default invoice transaction rule 504 (e.g., where the recommendation 522 may be based on insights (not shown) in an insights area 524). Although insights and recommendations are currently displayed for default transaction rules, insights and recommendations can be displayed for country rules and/or supplier group rules, for example, in response to selection of a country rule tab 526 or a supplier group tab 528, respectively.

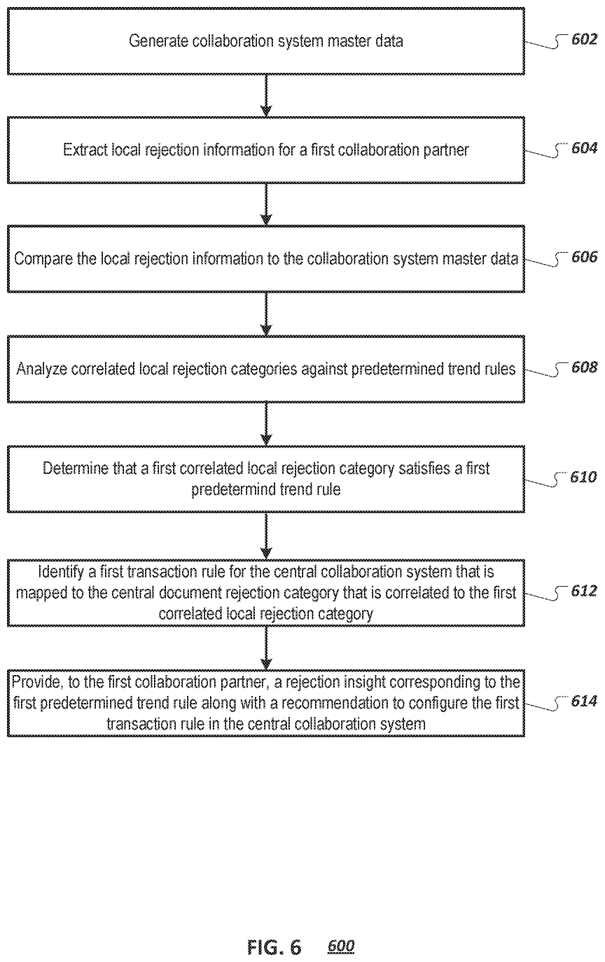

FIG. 6 is a flowchart of an example method for intelligent rule configuration in a collaboration system. It will be understood that method 600 and related methods may be performed, for example, by any suitable system, environment, software, and hardware, or a combination of systems, environments, software, and hardware, as appropriate. For example, one or more of a client, a server, or other computing device can be used to execute method 600 and related methods and obtain any data from the memory of a client, the server, or the other computing device. In some implementations, the method 600 and related methods are executed by one or more components of the system 100 described above with respect to FIG. 1. For example, the method 600 and related methods can be executed by the collaboration system 102 of FIG. 1.

At 602, collaboration system master data is generated, in a central collaboration system that manages collaborations between different collaboration partners. The collaboration system metadata describes central document rejection types for central rejections of documents by the central collaboration system of documents provided by collaboration partners to the central collaboration system. The collaboration system metadata can include document fields corresponding to the central document rejection types. The central collaboration system can map central rejection categories and document fields to transaction rules in the central collaboration system. Generating the collaboration system master data can include prompting a generative large language model to generate the collaboration system master data.

At 604, local rejection information is extracted, for a first collaboration partner, of rejections of documents by the first collaboration partner of documents forwarded to the first collaboration partner by the central collaboration system. The local rejection information includes local rejection categories and corresponding document fields. Extracting the local rejection information can include prompting a generative large language model to extract the local rejection information.

At 606, the local rejection information is compared to the collaboration system master data by prompting a generative large language model. Comparing includes matching at least some of the local rejection categories and document fields in the local rejection information to corresponding central document rejection categories and document fields in the collaboration system master data to identify correlated local rejection categories that are correlated to a corresponding central document rejection category.

At 608, correlated local rejection categories are analyzed against at least one predetermined trend rule.

At 610, a determination is made that a first correlated local rejection category satisfies a first predetermined trend rule.

At 612, a first transaction rule for the central collaboration system is identified that is mapped to the central document rejection category that is correlated to the first correlated local rejection category.

At 614, a rejection insight corresponding to the first predetermined trend rule is provided to the first collaboration partner along with a recommendation for the first collaboration partner to configure the first transaction rule in the central collaboration system.

After providing the recommendation to the first collaboration partner, a request can be received from the first collaboration partner to configure the first transaction rule in the central collaboration system. The first transaction rule can be configured in the central collaboration system for the first collaboration partner in response to the request. After the first transaction rule has been configured, a first document can be received from a second collaboration partner that is targeted to the first collaboration partner. The first document can be rejected in the central collaboration system based on the first transaction rule.

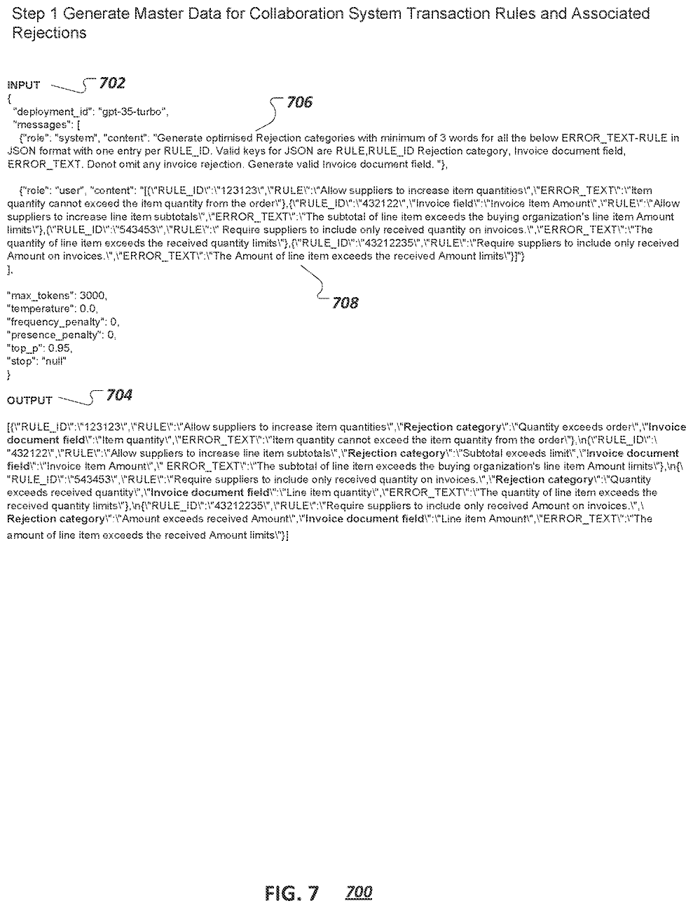

FIG. 7 illustrates example large language model information 700 for generating master data for collaboration system transaction rules and associated rejections. For example, the collaboration system can provide prompt information 702 to a large language model to generate master data 704 for collaboration system transaction rules and associated rejections. In further detail, a prompt 706 can prompt the large language model to generate categories for collaboration system rejections and corresponding transaction rules. The prompt 706 prompts the large language model to generate valid keys in a JSON (JavaScript Object Notation) format, along with a corresponding document (e.g., invoice) field. Input data 708 can be provided for the large language model to use when responding to the prompt 706. The input data 708 includes data in a JSON format that includes rule identifiers with corresponding rule and error text associated with the rule that has been retrieved from the collaboration system.

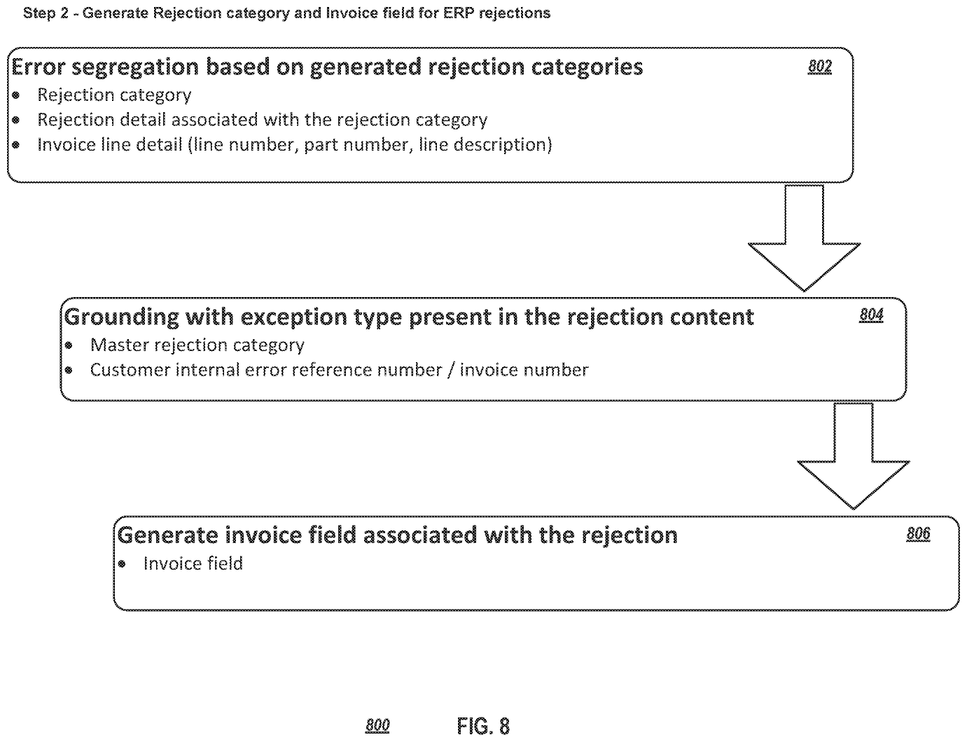

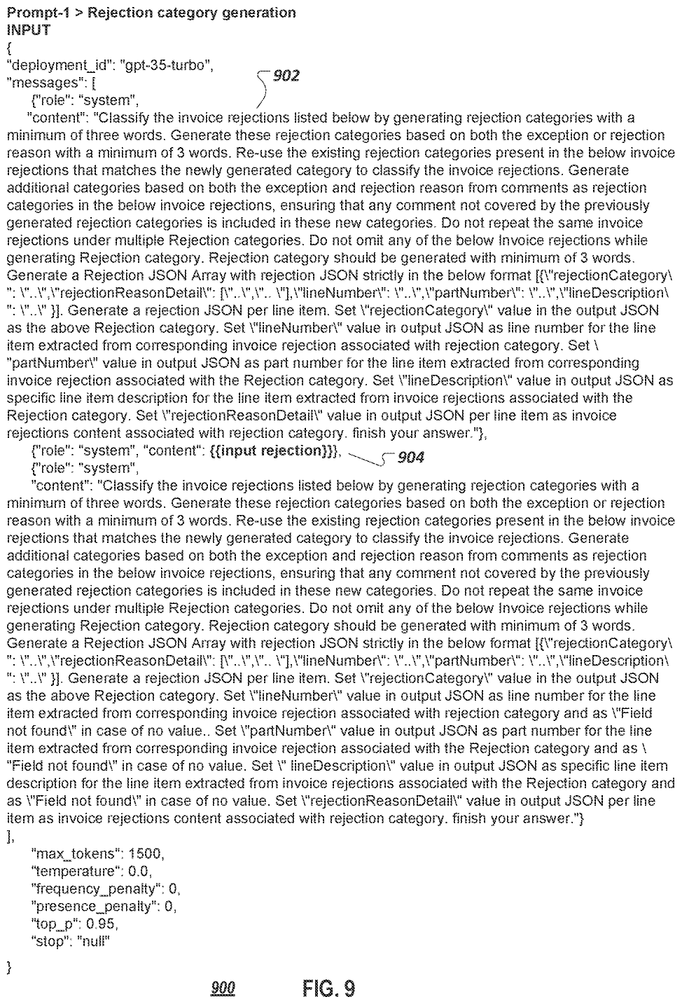

FIGS. 8-11 illustrate example large language model information for generation of rejection category and document fields for ERP rejections. FIG. 8 is a diagram that illustrates prompt chaining for generation of rejection category and document fields for ERP rejections. A first prompt 802 (described in more detail below with respect to FIG. 9) can be provided to the large language model to prompt the large language model to perform error segregation based on generated rejection categories. Output from the prompt 802 can include rejection category information, rejection detail information associated with respective rejection categories, and invoice line detail (e.g., line number, part number, line description).

The output from the prompt 802 can be provided to a prompt 804. The prompt 804 can be provided to the large language model to prompt the large language model to ground the large language model with exception type information present in rejection content. Output from the prompt 804 can include master rejection category information and customer internal error reference number (e.g., invoice number) information. The output from the prompt 804 can be provided to a prompt 806. The prompt 806 can be provided to the large language model to prompt the large language model to generate document field (e.g., invoice field) information associated with respective rejection(s).

FIG. 9 illustrates example large language model information 900 for rejection category generation. The large language model information 900 corresponds to the prompt 802 described above with respect to FIG. 8. For example, a prompt 902 can be provided to the large language model to prompt the large language model to segregate ERP rejections in received rejection information 904 on a basis of generated rejection categories with a minimum of three words. The received (e.g. inputted) rejection information 904 may include multiple rejections, for example (e.g., at different levels).

The prompt 902 can also prompt the large language model to reuse categories, if certain categories are already present in the rejection, and to generate additional rejection categories based on comments in rejection strings. The prompt 902 also prompts the large language model to not repeat rejections under multiple rejection categories and to not omit any rejections. The prompt 902 prompts the large language model to generate rejection information for respective rejections in a certain JSON format, and to assign line number, part number, line description, and rejection detail information for each rejection category.

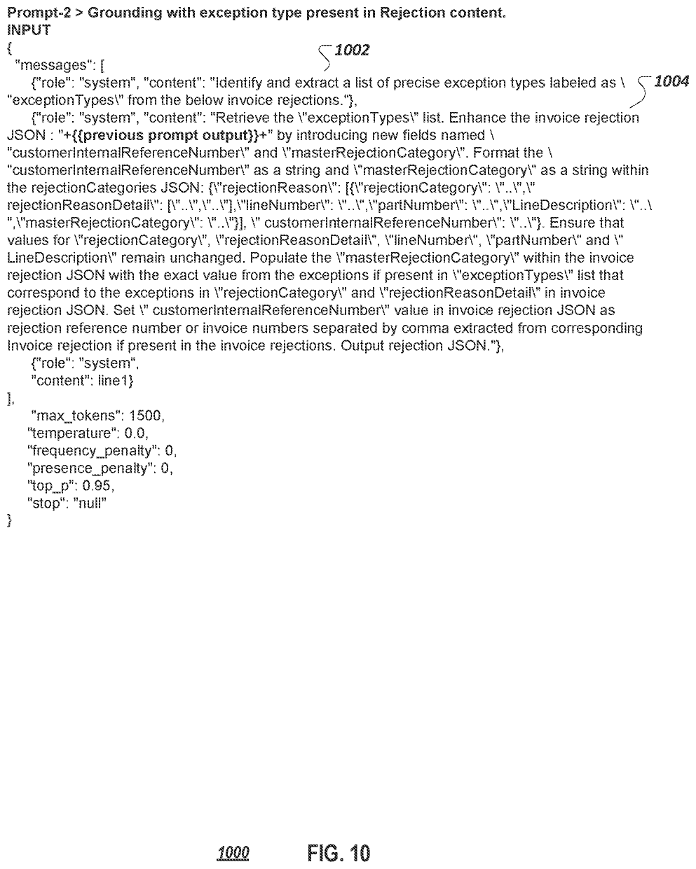

FIG. 10 illustrates example large language model information 1000 for grounding a large language model with exception type information present in rejection content. The large language model information 1000 corresponds to the prompt 804 described above with respect to FIG. 8. The large language model information 1000 includes a prompt 1002 that prompts the large language model to retrieve exception type information from document (e.g., invoice) rejection information. The document rejection information includes output from the large language model processing the prompt 902 described above with respect to FIG. 9, for example. The output from the prompt 902 is represented as “{{previous prompt output}}” in a prompt 1004. The prompt 1004 also prompts the large language model to add internal reference information and master rejection category information to the rejection.

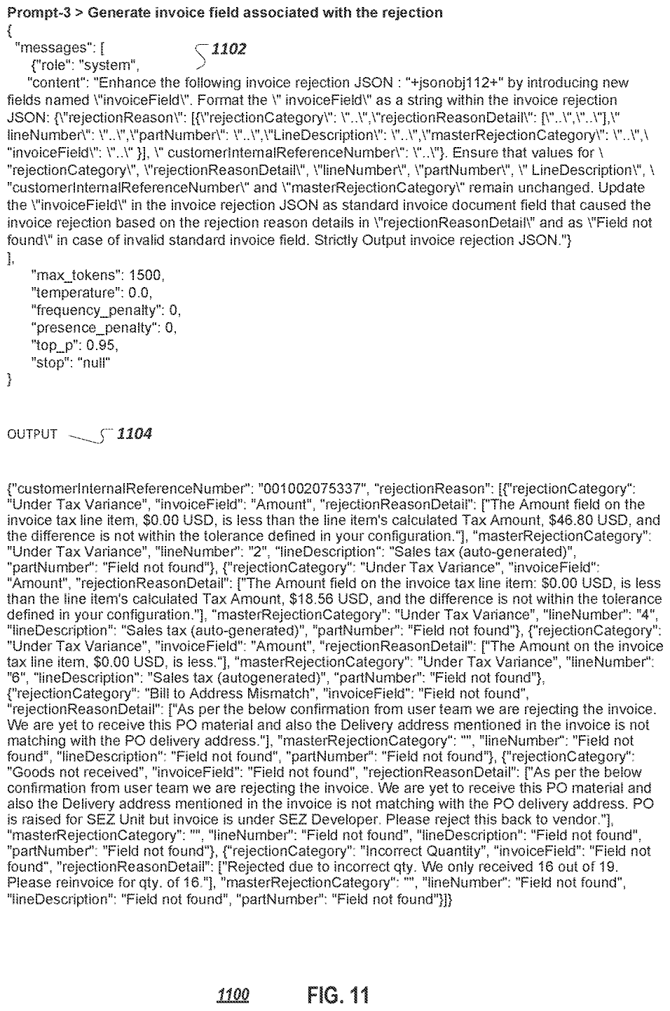

FIG. 11 illustrates example large language model information 1100 for generating a document field associated with a rejection. The large language model information 1100 corresponds to the prompt 806 described above with respect to FIG. 8. A prompt 1102 can prompt the large language model to add rejection field information to document rejection information (e.g., invoice rejection JSON data) and to generate JSON output (e.g., example output 1104) as a final output of prompt chaining (e.g., chaining of the prompts 802, 804, and 806 as described above with respect to FIG. 8).

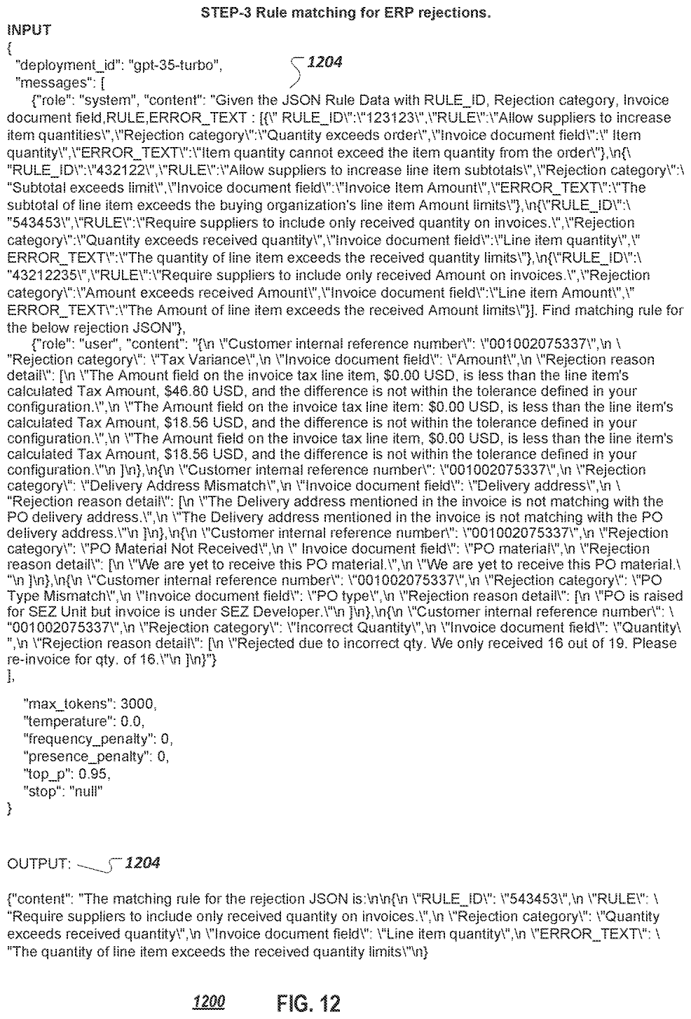

FIG. 12 illustrates example large language model information 1200 for rule matching for ERP rejections. A prompt 1202 can prompt the large language model to find matching collaboration system rejections that match ERP rejections. Output 1204 from the large language model responding to the prompt 1202 can include matching rules.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer-implemented method comprising:
generating, in a central collaboration system that manages collaborations between different collaboration partners, collaboration system master data that describes central document rejection types for central rejections of documents by the central collaboration system of documents provided by collaboration partners to the central collaboration system;
extracting, for a first collaboration partner, local rejection information of documents by the first collaboration partner of documents forwarded to the first collaboration partner by the central collaboration system, wherein the local rejection information comprises local rejection categories and corresponding document fields;
comparing the local rejection information to the collaboration system master data by prompting a generative large language model, wherein the comparing includes matching at least some of the local rejection categories and document fields in the local rejection information to corresponding central document rejection categories and document fields in the collaboration system master data to identify correlated local rejection categories that are correlated to a corresponding central document rejection category;
analyzing correlated local rejection categories against at least one predetermined trend rule; and
in response to determining that a first correlated local rejection category satisfies a first predetermined trend rule:
identifying a first transaction rule for the central collaboration system that is mapped to a central document rejection category that is correlated to the first correlated local rejection category; and
providing, to the first collaboration partner, a rejection insight corresponding to the first predetermined trend rule along with a recommendation for the first collaboration partner to configure the first transaction rule in the central collaboration system.

2. The computer-implemented method of claim 1, further comprising:
receiving, after providing the recommendation to the first collaboration partner, a request from the first collaboration partner to configure the first transaction rule;
configuring the first transaction rule in the central collaboration system for the first collaboration partner;
receiving, after the first transaction rule has been configured for the first collaboration partner in the central collaboration system, a first document from a second collaboration partner that is targeted to the first collaboration partner; and
rejecting, in the central collaboration system, the first document based on the first transaction rule.

3. The computer-implemented method of claim 1, wherein generating the collaboration system master data comprises prompting a generative large language model to generate the collaboration system master data.

4. The computer-implemented method of claim 1, wherein extracting the local rejection information comprises prompting a generative large language model to extract the local rejection information.

5. The computer-implemented method of claim 1, wherein the collaboration system master data maps central rejection categories and document fields to transaction rules in the central collaboration system.

6. The computer-implemented method of claim 1, wherein the first transaction rule is a default rule that is configured for all collaboration partners with which the first collaboration partner collaborates.

7. The computer-implemented method of claim 1, wherein the first transaction rule is a group rule that is configured for a particular group of collaboration partners with which the first collaboration partner collaborates.

8. The computer-implemented method of claim 1, wherein the first transaction rule is a geographic rule that is configured for all collaboration partners of a particular geographic area with which the first collaboration partner collaborates.

9. A system comprising:
one or more computers; and
a computer-readable medium coupled to the one or more computers having instructions stored thereon which, when executed by the one or more computers, cause the one or more computers to perform operations comprising:
generating, in a central collaboration system that manages collaborations between different collaboration partners, collaboration system master data that describes central document rejection types for central rejections of documents by the central collaboration system of documents provided by collaboration partners to the central collaboration system;
extracting, for a first collaboration partner, local rejection information of documents by the first collaboration partner of documents forwarded to the first collaboration partner by the central collaboration system, wherein the local rejection information comprises local rejection categories and corresponding document fields;
comparing the local rejection information to the collaboration system master data by prompting a generative large language model, wherein the comparing includes matching at least some of the local rejection categories and document fields in the local rejection information to corresponding central document rejection categories and document fields in the collaboration system master data to identify correlated local rejection categories that are correlated to a corresponding central document rejection category;
analyzing correlated local rejection categories against at least one predetermined trend rule; and
in response to determining that a first correlated local rejection category satisfies a first predetermined trend rule:
identifying a first transaction rule for the central collaboration system that is mapped to a central document rejection category that is correlated to the first correlated local rejection category; and
providing, to the first collaboration partner, a rejection insight corresponding to the first predetermined trend rule along with a recommendation for the first collaboration partner to configure the first transaction rule in the central collaboration system.

10. The system of claim 9, wherein the operations further comprise:
receiving, after providing the recommendation to the first collaboration partner, a request from the first collaboration partner to configure the first transaction rule;
configuring the first transaction rule in the central collaboration system for the first collaboration partner;
receiving, after the first transaction rule has been configured for the first collaboration partner in the central collaboration system, a first document from a second collaboration partner that is targeted to the first collaboration partner; and
rejecting, in the central collaboration system, the first document based on the first transaction rule.

11. The system of claim 9, wherein generating the collaboration system master data comprises prompting a generative large language model to generate the collaboration system master data.

12. The system of claim 9, wherein extracting the local rejection information comprises prompting a generative large language model to extract the local rejection information.

13. The system of claim 9, wherein the collaboration system master data maps central rejection categories and document fields to transaction rules in the central collaboration system.

14. The system of claim 9, wherein the first transaction rule is a default rule that is configured for all collaboration partners with which the first collaboration partner collaborates.

15. A computer program product encoded on a non-transitory storage medium, the product comprising non-transitory, computer readable instructions for causing one or more processors to perform operations comprising:
generating, in a central collaboration system that manages collaborations between different collaboration partners, collaboration system master data that describes central document rejection types for central rejections of documents by the central collaboration system of documents provided by collaboration partners to the central collaboration system;
extracting, for a first collaboration partner, local rejection information of documents by the first collaboration partner of documents forwarded to the first collaboration partner by the central collaboration system, wherein the local rejection information comprises local rejection categories and corresponding document fields;
comparing the local rejection information to the collaboration system master data by prompting a generative large language model, wherein the comparing includes matching at least some of the local rejection categories and document fields in the local rejection information to corresponding central document rejection categories and document fields in the collaboration system master data to identify correlated local rejection categories that are correlated to a corresponding central document rejection category;
analyzing correlated local rejection categories against at least one predetermined trend rule; and
in response to determining that a first correlated local rejection category satisfies a first predetermined trend rule:
identifying a first transaction rule for the central collaboration system that is mapped to a central document rejection category that is correlated to the first correlated local rejection category; and
providing, to the first collaboration partner, a rejection insight corresponding to the first predetermined trend rule along with a recommendation for the first collaboration partner to configure the first transaction rule in the central collaboration system.

16. The computer program product of claim 15, wherein the operations further comprise:
receiving, after providing the recommendation to the first collaboration partner, a request from the first collaboration partner to configure the first transaction rule;
configuring the first transaction rule in the central collaboration system for the first collaboration partner;
receiving, after the first transaction rule has been configured for the first collaboration partner in the central collaboration system, a first document from a second collaboration partner that is targeted to the first collaboration partner; and
rejecting, in the central collaboration system, the first document based on the first transaction rule.

17. The computer program product of claim 15, wherein extracting the local rejection information comprises prompting a generative large language model to extract the local rejection information.

18. The computer program product of claim 15, wherein the first transaction rule is a default rule that is configured for all collaboration partners with which the first collaboration partner collaborates.

19. The computer program product of claim 15, wherein the first transaction rule is a group rule that is configured for a particular group of collaboration partners with which the first collaboration partner collaborates.

20. The computer program product of claim 15, wherein the first transaction rule is a geographic rule that is configured for all collaboration partners of a particular geographic area with which the first collaboration partner collaborates.
